(19) United States
(12) Patent Application Publication
(10) Pub. No.: US 2007/0290599 A1
(43) Pub. Date: Dec. 20, 2007

(54) FLAT FLUORESCENT LAMP AND LIQUID CRYSTAL DISPLAY DEVICE THEREOF

(76) Inventors: Chu-Chi Ting, Hualien County (TW); Yu-Heng Hsieh, Taipei City (TW); Jung-Ngn Chen, Taoyuan City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,055

(22) Filed: Jun. 14, 2006

(51) Int. Cl. H01J 1/62

(52) U.S. Cl. 313/493

(57) ABSTRACT

The present invention provides a flat fluorescent lamp (FFL), including a first substrate, a second substrate, a discharging gas, an electrode set, a dielectric layer and a fluorescent material. The first substrate has at least a first cavity and the second substrate has at least a second cavity. The first substrate and the second substrate are oppositely connected to each other, thus allowing the first cavity together with the second cavity define a discharging space thereby. The discharging gas, the fluorescent material and the electrode set are all disposed in the discharging space. The electrode set is interposed between the first cavity and the second cavity and is adapted for providing a discharging electric field mostly distributed in the discharging space defined therein. In addition, a liquid crystal display (LCD) device using such an FFL is also proposed.

### BACKGROUND OF THE INVENTION

1. Field of the Invention

The present invention relates to a flat fluorescent lamp and a liquid crystal display (LCD) device using the same, and particularly to a flat fluorescent lamp with a high light-emitting efficiency and an LCD using the same.

2. Description of Related Art

In recent years, as the modern technology is rapidly developed, LCD devices are widely used as displays for consumer electronic devices, e.g. cellular phones, notebook computers, personal computers and personal digital assistants. However, a typical LCD itself does not emit light. Therefore, a backlight module is needed to be disposed under the LCD panel for providing a light source and whereby to enable the LCD panel to display. Conventional backlight modules generally include flat fluorescent lamps (FFLs), cold cathode fluorescent lamps (CCFLs) and light emitting diodes (LEDs). In particular, FFLs are more often used in LCD devices than others because they are cheap and compact.

FIG. 1 is a cross-sectional side view partly showing a conventional FFL. Referring to FIG. 1, the conventional FFL 100 is configured by an upper substrate 110 and a lower substrate 120 facing to each other. The first substrate 110 and the second substrate 120 define discharging space, in which discharging gas 130 is distributed. There is an electrode set 140 configured on the lower substrate 120 and a dielectric layer 150 disposed on the electrode set 140 for protecting the electrode set 140 thereby. Further, a fluorescent material 160 is disposed on the inner sidewalls of the upper substrate 110 and the lower substrate 120, as well as the outer sidewalls of the dielectric layer 150.

For driving such an FFL 100, a driving voltage is firstly applied to the electrode set 140 to generate a discharging electric field E. The discharging electric field E dissociates the discharging gas 130 to form plasma thereby. The plasma contains a plurality of ions having electrons of an excited state. As jumping back to a ground state, the electrons emit ultraviolet rays, which can excite the fluorescent material 160 to emit lights. Herein, the light emitting efficiency is determined by the degree of the discharging electric field E dissociating the discharging gas 130. Because the electrode set 140 is disposed on a surface of one side of the lower substrate 120, the discharging electric field E is generally divided into a discharging electric field Eᵢₙ located in the discharging space and a discharging electric field Eₒᵤₜ distributed at an external side of the substrate 120. However, only the discharging electric field Eᵢₙ is adapted for dissociating the discharging gas 130. Therefore, since the discharging electric field Eₒᵤₜ can not be fully utilized, the light emitting efficiency of the FFL 100 can not be further improved.

FIG. 2 is a cross-sectional side view partly showing another conventional FFL. Referring to FIG. 2, the conventional FFL 200 is configured by combining an upper substrate 210 and a lower substrate 220. The upper substrate 210 has a plurality of cavities 212 defined thereby for together with the lower substrate 220 forming a discharging space, in which discharging gas 230 is distributed. An electrode set 240 is configured at the outer sidewalls of the lower substrate 220. A fluorescent material 260 is disposed on the upper substrate 210 and the inner walls of the lower substrate 220. Similar with the foregoing discussion, the electrode set 240 generates a discharging electric field E. The discharging electric field E dissociates the discharging gas 230 to form plasma thereby. The plasma emits ultraviolet rays, which can excite the fluorescent material 260 to emit lights. However, since a part of the discharging electric filed Eₒᵤₜ is out of the discharging space, only the part of the discharging electric field Eᵢₙ is adapted for dissociating the discharging gas 230. Consequently, the discharging electric field Eₒᵤₜ is wasted while only the discharging electric field Eᵢₙ is utilized for dissociating the discharging gas 230. As a result, the light emitting efficiency of such an FFL 200 is limited and hardly to be upgraded.

### SUMMARY OF THE INVENTION

Therefore, an object of the invention is to provide an FFL, which is adapted for sufficiently utilizing a discharging electric field, thus performing a better light emitting efficiency.

Another object of the invention is to provide an LCD device using the foregoing FFL, and thus having better displaying illuminance and displaying performance.

According to the foregoing objects and others, the present invention provide an FFL, including a first substrate, a second substrate, a discharging gas, an electrode set, a dielectric layer and a fluorescent material. The first substrate has at least a first cavity and the second substrate has at least a second cavity. The first substrate and the second substrate are oppositely connected to each other, thus allowing the first cavity together with the second cavity define a discharging space thereby. The discharging gas, the fluorescent material and the electrode set are all disposed in the discharging space. The electrode set is interposed between the first cavity and the second cavity and is adapted for providing a discharging electric field in the discharging space defined therein. The electrode set is also covered by the dielectric layer.

According to an embodiment of the FFL of the present invention, the electrode set for example is disposed on the second substrate and includes a first strip electrode and a second strip electrode which are disposed abreast to each other. The first cavity includes a first slot, and the second cavity includes a second slot. The second slot is located between the first strip electrode and the second strip electrode. Moreover, the first slot and the second slot, for example, have sections in one of a V-shape, a U-shape and other shapes.

According to an embodiment of the FFL of the present invention, the electrode set, for example, includes a plurality of first strip electrodes and at least a second strip electrode. The second strip electrode is disposed between a pair of adjacent first electrodes and is disposed abreast to the first electrodes.

According to the foregoing embodiment, the electrode set, for example, is disposed on the second substrate. The first cavity includes a first slot, and the second cavity is composed of a plurality of second slots parallel to each other. Each second slot is located between a first strip electrode and a second strip electrode which are next to each other. Moreover, the first slot and the second slots, for example, have sections either in one of a V-shape, a U-shape and other shapes.

According to the foregoing objects and others, the present invention provides an LCD device. The LCD device includes an LCD panel and an FFL. The FFL is disposed at a side of the LCD panel for providing a backlight source to the LCD panel. The FFL includes a first substrate, a second substrate, a discharging gas, an electrode set, a dielectric layer and a fluorescent material. The first substrate includes at least a first cavity, and the second substrate has at least a second cavity. Wherein, the first substrate and the second substrate are oppositely connected to each other thus allowing the first cavity together with the second cavity define a discharging space thereby. The discharging gas, the fluorescent material and the electrode set are all secured in the discharging space. The electrode set is interposed between the first cavity and the second cavity and is adapted for providing a discharging electric field in the discharging space defined therein. The electrode set is covered by the dielectric layer.

According to an embodiment of the LCD device of the present invention, the electrode set, for example, is disposed on the second substrate and includes a first strip electrode and a second strip electrode which are disposed parallel to each other. The first cavity includes a first slot and the second cavity includes a second slot. The second slot is located between the first strip electrode and the second strip electrode. Moreover, the first slot and the second slot, for example, have sections either in one of a V-shape, a U-shape and other shapes.

According to an embodiment of the LCD device of the present invention, the electrode set, for example, includes a plurality of first strip electrodes and at least a second strip electrode. The second strip electrode is disposed between a pair of adjacent first electrodes and is disposed abreast to the first electrodes.

According to the foregoing embodiment, the electrode set, for example, is disposed on the second substrate. The first cavity includes a first slot, and the second cavity is composed of a plurality of second slots parallel to each other. Each second slot is located between a first strip electrode and a second strip electrode which are next to each other. Moreover, the first slot and the second slots, for example, have sections either of a V-shape or of a U-shape.

In summary, according to the present invention, the FFL has most electric field distributed in the discharging space defined by the first cavity of the first substrate and the second cavity of the second substrate. The dissociating degree of the discharging gas can be largely improved and the light emitting efficiency of the FFL can also be significantly enhanced. Moreover, facilitating with an FFL having a higher light emitting efficiency, an LCD using such an FFL can achieve a better displaying illuminance and displaying performance.

### BRIEF DESCRIPTION OF THE DRAWINGS

The features of the invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a cross-sectional side view partly showing a conventional FFL;

FIG. 2 is a cross-sectional side view partly showing another conventional FFL;

FIG. 3A is a schematic isometric view partly illustrating an FFL according to an embodiment of the invention;

FIG. 3B is a sectional view of an FFL of FIG. 3A;

FIGS. 3C to 3E are top views partly shows different types of electrode set according to FIG. 3A respectively.

FIG. 4A is a schematic isometric view illustrating an FFL according to another embodiment of the invention;

FIG. 4B is a sectional view an FFL of FIG. 4A;

FIG. 4C to 4E are top views partly shows different types of electrode set according to FIG. 4A respectively.

FIG. 5 is a schematic isometric view partly illustrating an FFL according to a further embodiment of the invention;

FIGS. 6 and 7 are schematic isometric views partly and respectively illustrating the first substrates according to the embodiments of the invention; and

FIG. 8 is a schematic view of an LCD device according to an embodiment of the invention.

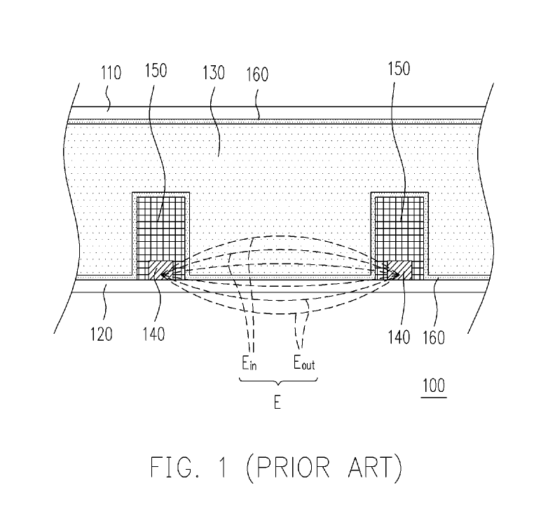

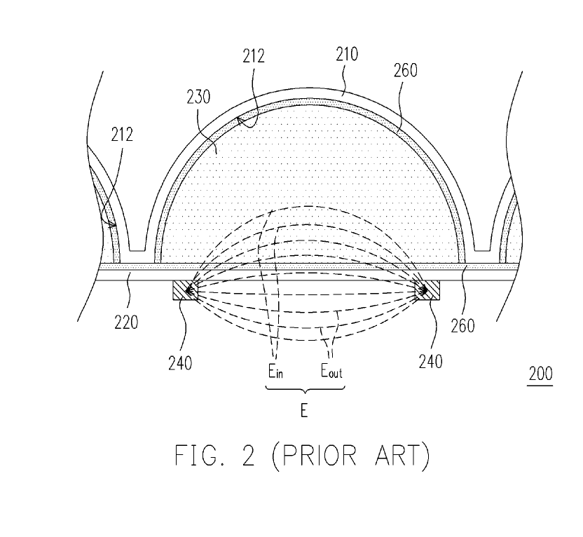

### DESCRIPTION OF THE EMBODIMENTS

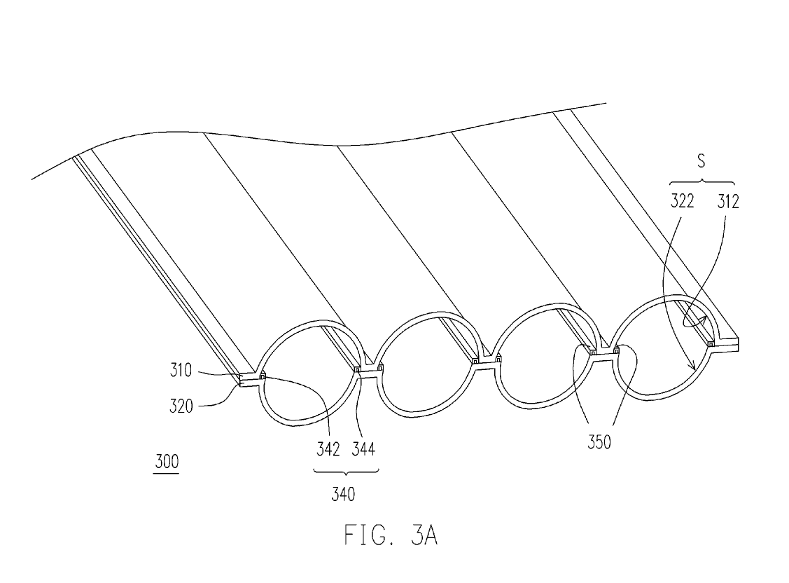

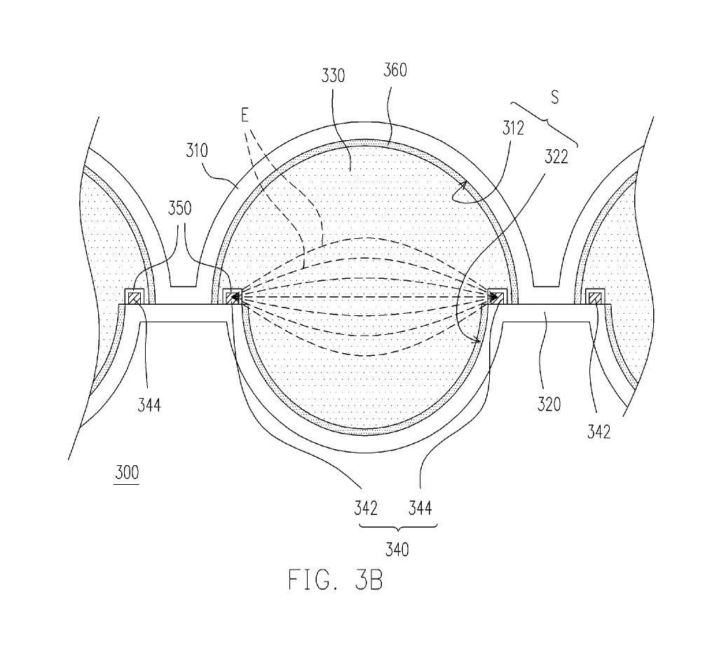

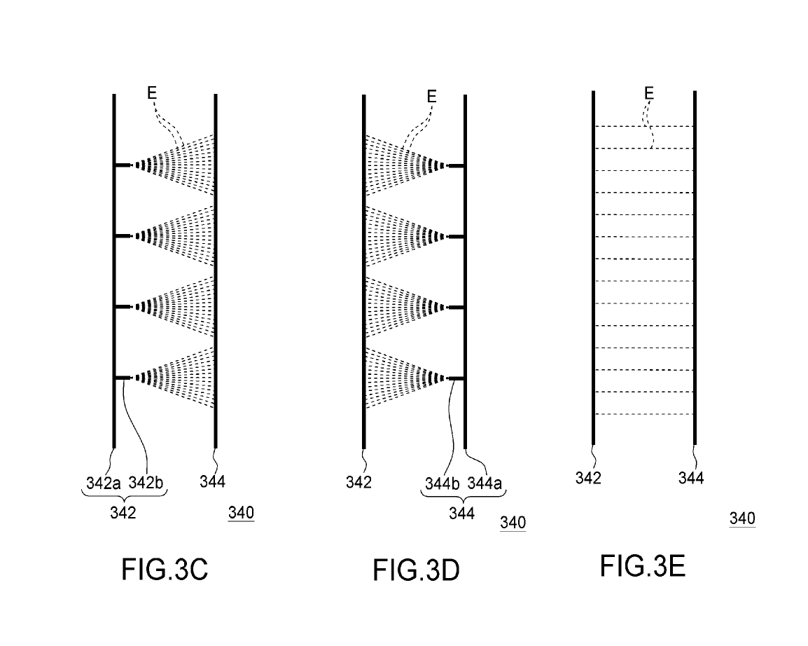

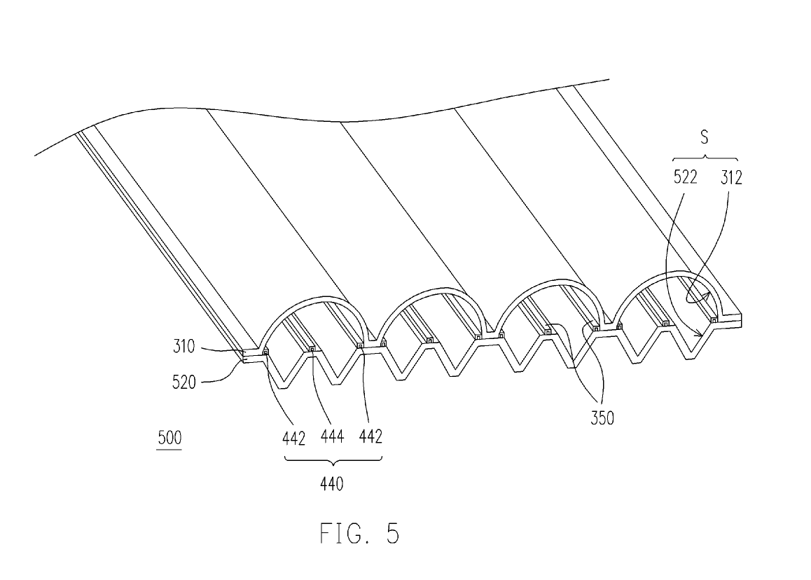

FIG. 3A is a schematic isometric view partly illustrating an FFL according to an embodiment of the invention and FIG. 3B is a sectional view of an FFL of FIG. 3A. Together referring to FIGS. 3A and 3B, an FFL 300 according to an embodiment of the invention generally includes a first substrate 310, a second substrate 320, a discharging gas 330, an electrode set 340, a second dielectric layer 350 and a fluorescent material 360. The first substrate 310 has a first cavity 312 and the second substrate 320 has a second cavity 322. The first substrate 310 and the second substrate 320 are oppositely connected to each other thus allowing the first cavity 312 together with the second cavity 322 define a discharging space S thereby. According to the embodiment, the first cavity 312 and the second cavity 322 are preferably configured as a semi-circle sectional slot. However, the sections of the slots may also be U-shaped or V-shaped (as shown the second cavity 522 of FIG. 5) or other suitable shapes. Moreover, the first cavity and the second cavity are not limited to be configured as slots. In other embodiments, they may also be configured as receiving holes. The first substrate 310 and the second substrate 320 are preferably made of either glass material or transparent plastic material. To form the first substrate 310 and the second substrate 320, a hot-press method is usually employed, in which a specifically designed mold is used to press the heated substrates under a condition of a given high temperature for transferring patterns correspondingly to the substrates and forming certain patterns of the first cavity 312 and the second cavity 322. However, they can also be made with other methods, for example, ejection molding method.

The discharging gas 330, the fluorescent material 360 and the electrode set 340 are all secured in the discharging space S. The electrode set 340 is interposed between the first cavity 312 and the second cavity 322 and is adapted for providing a discharging electric field E in the discharging space S defined therein to dissociate the discharging gas 330 into plasma. The plasma contains a plurality of ions having electrons of an excited state. As jumping back to a ground state, the electrons emit ultraviolet rays, which can excite the fluorescent material 360 to emit lights. According to the invention, the first cavity 312 and the second cavity 322 are disposed respectively at two sides of the electrode set 340 and are opposed to each other. And therefore most electric field E provided by the electrode set 340 can be concentrated in the discharging space S. The dissociating degree of the discharging gas can be largely improved and the light emitting efficiency of the FFL 300 can also be enhanced.

Again referring to FIGS. 3A and 3B, the electrode set 340 according to the embodiment, for example, is disposed on the second substrate 320. The dielectric layer 350 covers the electrode set 340 for protecting the electrode set 340 from being bombarded by the ions of the plasma. The electrode set 340 includes a first strip electrode 342 and a second strip electrode 344 which are disposed abreast to each other. The first strip electrode 342 is used as an anode for providing a high voltage or used as a cathode for providing a low voltage, and the second strip electrode 344 is correspondingly used as a cathode for providing a low voltage or used as an anode for providing a high voltage. Therefore, a discharging electric filed E is generated in the discharging space S. The aforementioned driving method is conducted by direct current. However, in another method conducted by alternating current, the voltage of the first strip electrode 342 and the second strip electrode 344 varies for being either of an anode or a cathode alternately in different time domains.

The first strip electrode 342 and the second strip electrode 344, for example, can be formed with a printing method or a plating method. The position of the electrode set 340 is not limited according to the invention. For example, the anode and the cathode either be disposed on the first substrate 310, or be disposed respectively on the first substrate and the second substrate 320.

The discharging gas 330 can be an inert gas, e.g., Xe, Ne, Ar or any other suitable gases. The fluorescent material 360, for example, is formed on the inner surfaces of the first substrate 310 and the second substrate 320 by a spray method. It is to be noted that because the first substrate 310 and the second substrate 320 respectively have a first cavity 312 and a second cavity 322, they have larger inner areas than flat substrates. And consequently, the fluorescent material 360 is distributed on a larger area for reacting and thus improving the light emitting efficiency.

FIGS. 3C to 3E are top views partly shows different types of electrode set according to FIG. 3A respectively. Referring to FIG. 3C, the first strip electrode 342 comprises a strip body 342a and multiple protrusions 342b, wherein the protrusions 342b protrudes along a direction from one side of the strip body 342a to the second strip electrode 344. When a voltage is applied to the first strip electrode 342 and the second strip electrode 344, a discharging phenomenon occurs between tips of the protrusions 342b and the second strip electrode 344. Therefore, multiple dot-to-line discharging regions are formed.

Additionally, shapes of the first strip electrode 342 and the second strip electrode 344 can be exchanged in the present invention. Referring to FIG. 3D, the second strip electrode 344 comprises a strip body 344a and multiple protrusions 344b, wherein the protrusions 344b protrudes along a direction from one side of the strip body 344a to the first strip electrode 342. When a voltage is applied to the first strip electrode 342 and the second strip electrode 344, a discharging phenomenon occurs between tips of the protrusions 344b and the first strip electrode 342. Multiple dot-to-line discharging regions are therefore formed.

Furthermore, both of the first strip electrode 342 and the second strip electrode 344 can be linear in another embodiment as shown in FIG. 3E. When a voltage is applied to the first strip electrode 342 and the second strip electrode 344, a discharging phenomenon occurs between the first strip electrode 342 and the second strip electrode 344. Multiple line-to-line discharging regions are thus formed. It should be noted that the above-mentioned embodiments are only used for illustrating some specific shapes of the first strip electrode 342 and the second strip electrode 344 and provide no limitation on practical shapes of the first strip electrode 342 and the second strip electrode 344.

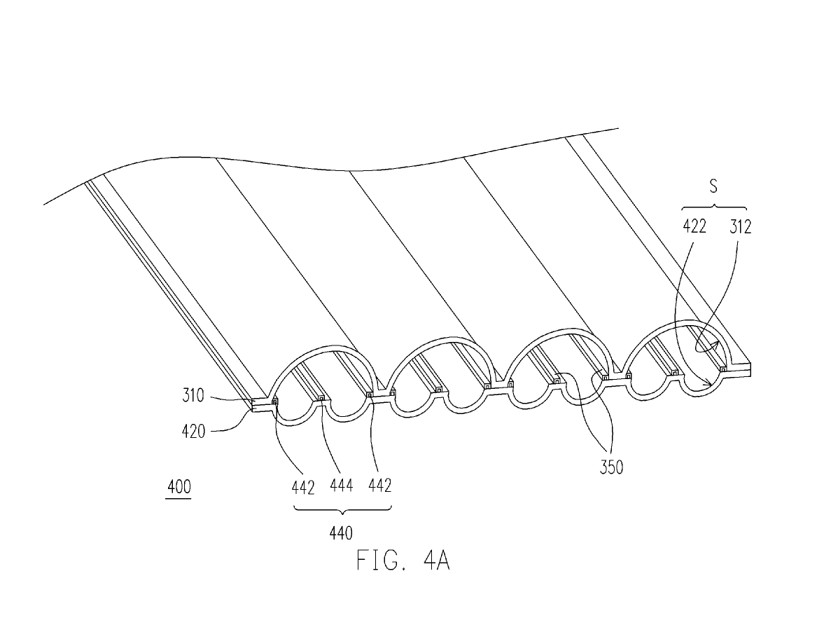

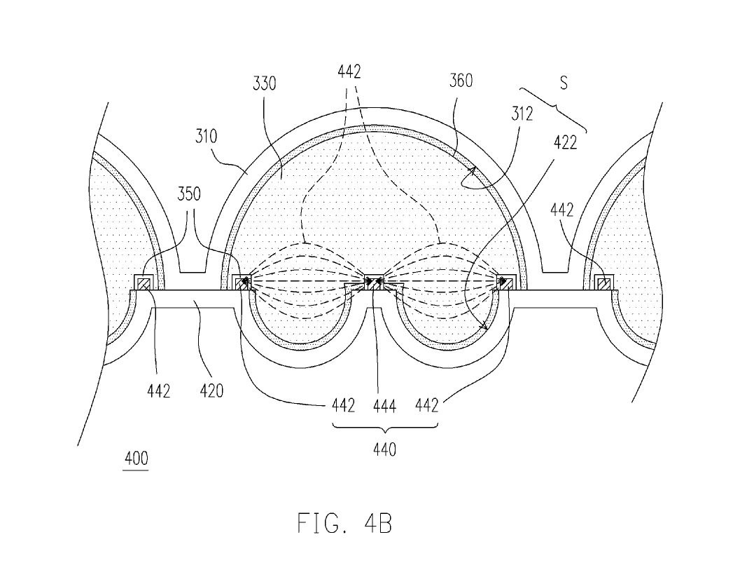

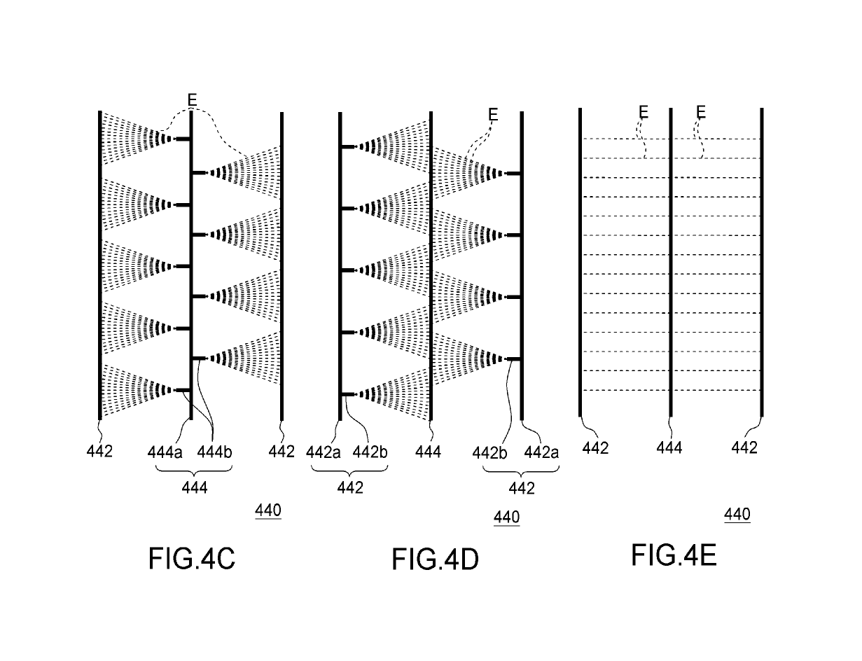

FIG. 4A is a schematic isometric view partly illustrating an FFL according to another embodiment of the invention and FIG. 4B is a sectional view of an FFL of FIG. 4A. Together referring to FIGS. 4A, 4B and FIGS. 3A and 3B, this embodiment is similar with the foregoing, and the difference therebetween is as illustrated below. According to the FFL 400 of the embodiment, the second cavity 422 of the second substrate 420 and the first cavity 312 of the first substrate 310 configure a discharging space S. Each of the second cavities 422, for example, is composed of two slots parallel to each other. Furthermore, the corresponding electrode set 440, for example, includes two first strip electrodes 442 and a second strip electrode 444. The first strip electrodes 442 and the second strip electrodes 444 are disposed on the second substrate 420, being parallel to one another. The second strip electrode 444 is disposed between two adjacent first strip electrodes 442. In operation, the first strip electrodes 442 are used as anodes for providing high voltages or used as cathodes for providing low voltages, and the second strip electrode 444 is correspondingly used as a cathode for providing a low voltage or used as an anode for providing a high voltage. Thus, a discharging electric field E is generated. Most of the discharging electric field E is distributed in the discharging space S. Thus, dissociating degree of the discharging gas can be largely improved and the light emitting efficiency of the FFL can also be increased.

However, neither the quantity of the slots of any second cavities 422 nor the quantity of the slots of any first cavity 312 should be limited according to the invention. For example, the first cavity 312 can include two or more slots and the second cavity 422 can include three or more slots, in which a suitable electrode set 440 is provided for providing a discharging electric field E in the discharging space S. Moreover, quantities of the first strip electrodes 442 and the second strip electrodes 444 are also not limited according to the invention. However, those skilled in the art should understand that the quantities and the positions of the first strip electrodes 442 and the second strip electrodes 444 should match the structure of the discharging space S for obtaining a better discharging effect.

FIG. 4C to 4E are top views partly shows different types of electrode set according to FIG. 4A respectively. Referring to FIG. 4C, the second strip electrode 444 comprises a strip body 444a and multiple protrusions 444b, wherein the protrusions 444b are arranged at two sides of the strip body 444a alternately and protrudes along a direction from the strip body 444a to the first strip electrodes 442. When a voltage is applied to the first strip electrodes 442 and the second strip electrode 444, a discharging phenomenon occurs between tips of the protrusions 444b and the first strip electrodes 442. Therefore, multiple discharging regions are formed.

Additionally, shapes of the first strip electrodes 442 and the second strip electrode 444 can be exchanged in the present invention. Referring to FIG. 4D, each first strip electrode 442 comprises a strip body 442a and multiple protrusions 442b, wherein the protrusions 442b protrudes along a direction from one side of the strip body 442a to the second strip electrode 444. When a voltage is applied to the first strip electrodes 442 and the second strip electrode 444, a discharging phenomenon occurs between tips of the protrusions 442b and the second strip electrode 444. Multiple discharging regions are therefore formed.

Furthermore, the first strip electrodes 442 and the second strip electrode 444 can be linear in another embodiment as shown in FIG. 4E. When a voltage is applied to the first strip electrodes 442 and the second strip electrode 444, multiple line-to-line discharging regions are formed between the first strip electrodes 442 and the second strip electrode 444.

FIG. 5 is a schematic isometric view partly illustrating an FFL according to a further embodiment of the invention. Together referring to FIGS. 5 and 4A, this embodiment is similar with the foregoing, while the difference therebetween is that the slots of the second cavity 522 of the second substrate 520 has a V-shaped sectional view according to the present embodiment. Most discharging electric field E is distributed in a discharging space S configured by the first cavity 312 and the second cavity 522, thus a better discharging effect can be obtained. Moreover, the variations of the shapes of the electrode set have been illustrated in the above, and the redundant detailed description is omitted.

In the foregoing embodiments, the first cavity of the first substrate and the second cavity of the second substrate may vary in many formats, e.g., quantity of receiving holes or slots, sectional shape of the slot. The first cavity and the second cavity are respectively disposed at two sides of the electrode set, which are opposed to each other for allowing most discharging electric field E distributed in the discharging space S configured by the first cavity and the second cavity. Those skilled in the art may select the first substrate and the second substrate in any types with a suitable electrode set within the spirit of the invention.

Moreover, in order to further improve the light emitting efficiency, the invention may further include means or structures on the inner surface of the first cavity and the second cavity for increasing surface area to improve reaction area of the fluorescent material.

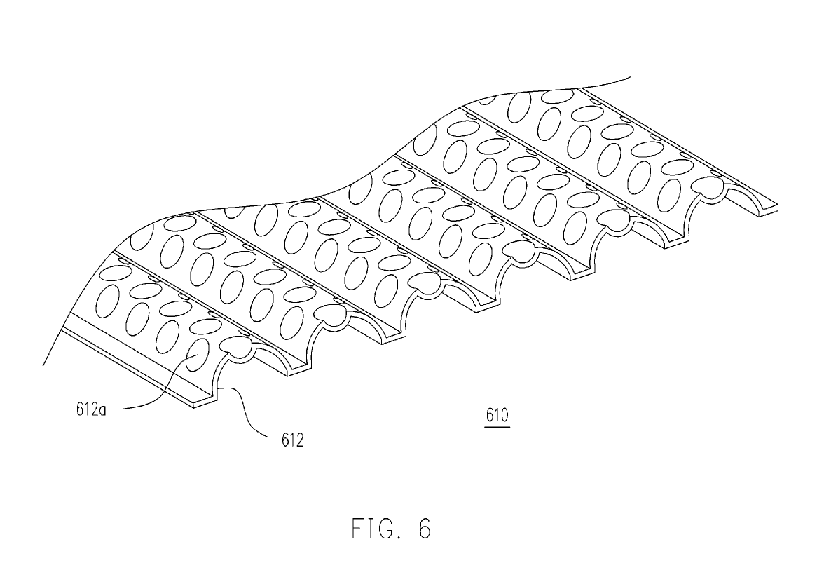

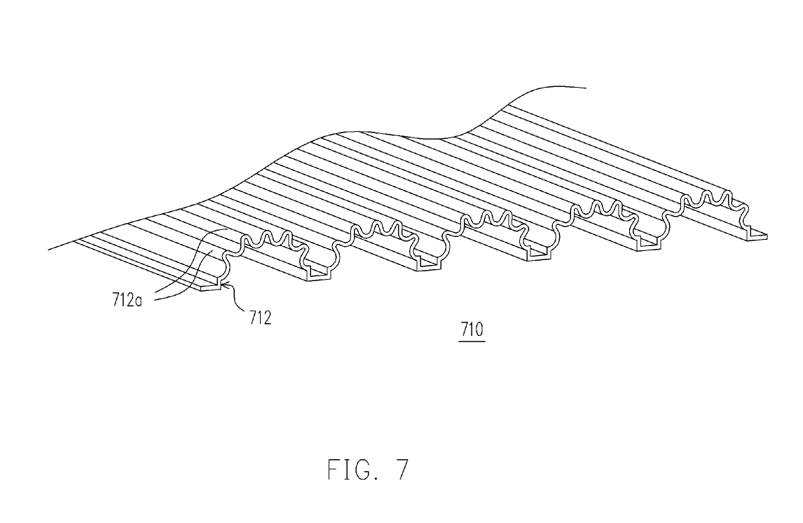

FIGS. 6 and 7 are schematic isometric views partly and respectively illustrating the first substrates according to the embodiments of the invention. Referring to FIG. 6, first, the first substrate 610 has a first cavity 612 configured as a slot, a plurality of receiving holes 612a being configured at the inner surface of the first cavity 612 for enlarging the area of the inner surface of the first cavity 612. When a fluorescent material is coated in such a first cavity 612, the fluorescent material has larger reacting area, and an FFL using such may obtain better light emitting efficiency. Similarly, according to the invention, forming a plurality of humps on the inner surface of the first cavity 612 can achieve the similar result.

Referring to FIG. 7, the first cavity 712 of the first substrate 710 is configured by a slot. Each first cavity 712 can further includes a plurality of slots 712a parallel to one another on the inner surface of the first cavity 712. Therefore, the first cavity 712 has a larger inner area. Similarly, the fluorescent material coated in such first cavity 712 has larger reacting area for further improving the light emitting efficiency of the FFL.

Further, the approach for configuring structures or means for enlarging inner surface area at the first cavity 612 or 712 is also adapted for the second cavity of the second substrate for enlarging surface area of the second inner surface. Those skilled in the art may use similar approaches to modify the shape or structure of the inner surfaces of the first cavity and the second cavity for enlarging inner surface area of the first cavity and the second cavity. It is also to be noted that the foregoing structures or means for enlarging inner surface areas, for example, can be formed integrally with the substrates by using a modified mold during a hot pressing process.

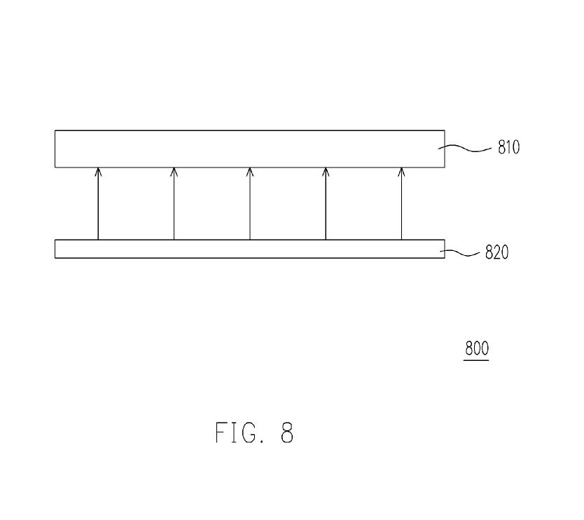

The FFL according to the present invention can be used in an LCD device. FIG. 8 is a schematic view of an LCD device according to an embodiment of the invention. An LCD device 800 according to an embodiment of the invention includes an LCD panel 810 and an FFL 820. The FFL can be of any foregoing embodiments, e.g., FFLs 300, 400, 500. The FFL 820 is disposed at a side of the LCD panel 810 for providing a backlight source to the LCD panel for providing a backlight source to the LCD panel 810 and allowing the LCD panel 810 to display. Because the FFL 810 according to the invention has better light emitting efficiency, the LCD device 800 using such an FFL 810 can achieve a better displaying illuminance and displaying performance. The FFL according to the invention not only can be used in an LCD device, but also can be used in any electronic devices which use a backlight source.

In summary, according to the invention, the FFL and the LCD device using the same have at least the advantages of:

Configuring a discharging space with a first cavity of a first substrate and a second cavity of a second substrate, disposing the first cavity and the second cavity respectively at two sides of an electrode set which are opposed to each other allow most discharging electric field distributed in the discharging space, thus obtaining a better discharging effect and improving the light emitting efficiency of the FFL;

Comparing to a flat substrate, a first substrate having a first cavity and a second substrate having a second cavity have larger inner surface areas. Therefore, the reacting area of the fluorescent material is larger for having a better light emitting efficiency. Further, forming structures for means for enlarging surface area at the inner surfaces of the first cavity and the second cavity can further improve the reacting effect of the fluorescent material;

Facilitating with an FFL having a higher light emitting efficiency, an LCD using such an FFL can achieve a better displaying illuminance and displaying performance.

Other modifications and adaptations of the above-described preferred embodiments of the present invention may be made to meet particular requirements. This disclosure is intended to exemplify the invention without limiting its scope. All modifications that incorporate the invention disclosed in the preferred embodiment are to be construed as coming within the scope of the appended claims or the range of equivalents to which the claims are entitled.

What is claimed is:

1. A flat fluorescent lamp (FFL) comprising:
a first substrate, having at least one first cavity;
a second substrate, having at least one second cavity, wherein the first substrate and the second substrate are oppositely connected to each other, thus allowing the first cavity together with the second cavity define a discharging space thereby;
a discharging gas, disposed in the discharging space;
an electrode set, being interposed between the first cavity and the second cavity and being adapted for providing a discharging electric field in the discharging space defined therein;
a dielectric layer, covering the electrode set; and
a fluorescent material, disposed in the discharging space.

2. The FFL according to claim 1, wherein the electrode set comprises a first strip electrode and a second strip electrode which are disposed abreast to each other.

3. The FFL according to claim 2, wherein the electrode set is disposed on the second substrate.

4. The FFL according to claim 3, wherein the first cavity comprises a first slot, and the second cavity comprises a second slot, the second slot being located between the first strip electrode and the second strip electrode.

5. The FFL according to claim 4, wherein the first slot and the second slot have sections in one of a V-shape, a U-shape and an irregular shape.

6. The FFL according to claim 1, wherein the electrode set comprises:
a plurality of first strip electrodes; and
at least one second strip electrode, being disposed between a pair of adjacent first electrodes and being abreast to the first electrodes.

7. The FFL according to claim 6, wherein the electrode set is disposed on the second substrate.

8. The FFL according to claim 7, wherein the first cavity comprises a first slot, and the second cavity is composed of a plurality of second slots parallel to each other, and each second slot is located between a first strip electrode and a second strip electrode which are next to each other.

9. The FFL according to claim 8, wherein the first slot and the second slots have sections in one of a V-shape, a U-shape and an irregular shape.

10. A liquid crystal display (LCD) device, comprising:
an LCD panel; and
a FFL, disposed at a side of the LCD panel for providing a backlight source to the LCD panel, the FFL comprising:
a first substrate, having at least one first cavity;
a second substrate, having at least one second cavity, wherein the first substrate and the second substrate are oppositely connected to each other, thus allowing the first cavity together with the second cavity define a discharging space thereby;
a discharging gas, disposed in the discharging space;
an electrode set, being interposed between the first cavity and the second cavity and being adapted for providing a discharging electric field in the discharging space defined therein;
a dielectric layer, covering the electrode set; and
a fluorescent material, disposed in the discharging space.

11. The LCD device according to claim 10, wherein the electrode set comprises a first strip electrode and a second strip electrode which are disposed abreast to each other.

12. The LCD device according to claim 11, wherein the electrode set is disposed on the second substrate.

13. The LCD device according to claim 12, wherein the first cavity comprises a first slot, and the second cavity comprises a second slot, the second slot being located between the first strip electrode and the second strip electrode.

14. The LCD device according to claim 13, wherein the first slot and the second slot have sections in one of a V-shape, a U-shape and an irregular shape.

15. The LCD device according to claim 10, wherein the electrode set comprises:
a plurality of first strip electrodes; and
at least one second strip electrode, being disposed between a pair of adjacent first electrodes and being abreast to the first electrodes.

16. The LCD device according to claim 15, wherein the electrode set is disposed on the second substrate.

17. The LCD device according to claim 16, wherein the first cavity comprises a first slot, and the second cavity is composed of a plurality of second slots parallel to each other, and each second slot is located between a first strip electrode and a second strip electrode which are next to each other.

18. The LCD device according to claim 17, wherein the first slot and the second slots have sections in one of a V-shape, a U-shape and an irregular shape.
